(19) United States
(12) Patent Application Publication
(10) Pub. No.: US 2003/0095663 A1
(43) Pub. Date: May 22, 2003

(54) System and method to provide enhanced security in a wireless local area network system

(76) Inventors: David B. Nelson, Derry, NH (US); Roger P. Durand, Amherst, NH (US); Julian Wray West, Salem, NH (US)

Correspondence Address: CHIRS A. CASEIRO, VERRILL AND DANA, LLP, ONE PORTLAND SQUARE, PORTLAND, ME, 04112-0586, US

(21) Appl. No.: 10/116,447

(22) Filed: Apr. 4, 2002

Related U.S. Application Data
(60) Provisional application No. 60/332,101, filed on Nov. 21, 2001.

(51) Int. Cl. H04L 9/00

(52) U.S. Cl. 380/270; 713/168

(57) ABSTRACT

A system and method for enhancing Wireless Local Area Network (WLAN) security. The system and method include the generation of a pair of WEP-based encryption keys by a network access point. The key pair is transmitted to one or more clients associated with the access point after the client has been authenticated for access to the network. Each key is preferably randomly generated and the pair is further changed periodically. The timing of the changing of the keys is dependent upon the existing crypto analysis attack capabilities. Individual clients may have unique key pairs or a plurality of clients associated with an access point may share the key pair.

### BACKGROUND OF THE INVENTION

1. Field of the Invention.

The present invention relates to wireless local area networks (WLANs). More particularly, the present invention relates to systems and methods to enhance the security of WLAN signal exchanges. Specifically, the present invention relates to systems and methods to establish secure encryption of standards-based WLAN exchanges.

2. Description of the Prior Art.

Computing systems are useful tools for the exchange of information among individuals. The information may include, but is not limited to, data, voice, graphics, and video. The exchange is established through interconnections linking the computing systems together in a way that permits the transfer of electronic signals that represent the information. The interconnections may be either wired or wireless. Wired connections include metal and optical fiber elements. Wireless connections include infrared and radio wave transmissions.

A plurality of interconnected computing systems having some sort of commonality represents a network. For example, individuals associated with a college campus may each have a computing device. In addition, there may be shared printers and remotely located application servers sprinkled throughout the campus. There is commonality among the individuals in that they all are associated with the college in some way. The same can be said for individuals and their computing arrangements in other environments including, for example, healthcare facilities, manufacturing sites and Internet access users. In most cases, it is desirable to permit communication or signal exchange among the various computing systems of the common group in some selectable way. The interconnection of those computing systems, as well as the devices that regulate and facilitate the exchange among the systems, represent a network. Further, networks may be interconnected together to establish internetworks.

The process by which the various computing systems of a network or internetwork communicate is regulated by agreed-upon signal exchange standards and protocols embodied in radio-enabled network interface cards or circuitry. Such standards and protocols were borne out of the need and desire to provide interoperability among the array of computing systems available from a plurality of suppliers. Two organizations that have been substantially responsible for signal exchange standardization are the Institute of Electrical and Electronic Engineers (IEEE) and the Internet Engineering Task Force (IETF). In particular, the IEEE standards for internetwork operability have been established, or are in the process of being established, under the purview of the 802 committee on Local Area Networks (LANs) and Metropolitan Area Networks (MANs).

The IETF has established a protocol to secure signal transmissions at Layer 4 of the Open Systems Interface (OSI). The Transport Layer Security (TLS) protocol defined by the IETF is based upon the Secure Sockets Layer (SSL) protocol and involves the encryption of transport layer transmissions based on a public key-private key exchange. Specifically, an end user contacts a service provider to gain access to the Internet. The answering server sends a public key to the user's browser that in turn generates a random private key that is employed for the remainder of the Internet session. A break in the signal exchange between the server and the browser requires re-initialization of the TLS protocol.

IEEE standard 802.1× in particular is designed to improve network security at Layer 3 of the OSI. It establishes a framework for network authentication of a user seeking to connect to a particular network and access programs associated with that network, and for distribution of encryption keys for use at Layer 2 of the OSI. When a user initiates connection to an access point port of the network, the access point initially only forwards user request information, including identity information pursuant to an authentication protocol, such as the Extensible Authentication Protocol (EAP), to network management. All other communication activities are blocked during the authentication process. An authentication server of the network then resolves the user's network access permissions, if any, and forwards an accept/reject message to the access point. The access point then either authorizes port access or it blocks access for the requesting user. 802.1× is applicable to wired and wireless network connections.

IEEE standard 802.11 is directed to wireless LAN (WLAN) standards and Layer 2 of the OSI in particular. The standard establishes a framework for the bands of radio signal propagation to enable bit transmission rates substantially compatible with existing expectations of network signal exchange rates. Whereas 802.1× defines network access authentication regardless of signal transmission medium, 802.11 is specifically directed to transmission standards in a wireless environment. Neither specifically addresses the security of signal exchanges in a wireless environment once network access has been established. However, it is known that wireless communications may be more susceptible to interception than signal transmissions on wired or fiber media. In addition, wireless communications may be used by unauthorized entities to access the network by spoofing the identity of an authenticated user. As a result of those concerns, wireless network communications are preferably encrypted. It is widely believed that the encryption of a wireless transmission equates to the security associated with a wired network for which physical security mechanisms are possible.

The Wired Equivalent Privacy (WEP) algorithm provides under 802.11 the standardized wireless encryption method. WEP involves the use of a secret or private key that is shared among one or more mobile computer systems and an access point that is wired to a network. The key, a string of bits, is combined with readable data in a defined mathematically determined manner to generate ciphered data. In particular, WEP uses the RC4 algorithm to generate a pseudo-random key stream that is combined with the data to generate encrypted data packets. The receiver, having the same key and algorithm, simply performs the inverse same mathematical function on the cipher stream to reproduce the readable data. In order to avoid duplicative ciphering, which aids crypto analysis, WEP further employs an initialization vector (IV), or public key, added to the secret key, prior to ciphering, to minimize re-use of the same effective cipher key. The IV is currently a 24-bit field that transmits in clear text. With sufficient traffic on the WLAN, the IV and corresponding private portion of the WEP key can be detected by crypto analysis, decrypted, and the network and its traffic exposed. It is desirable to avoid such an event. There have been some indications that existing crypto analysis attacks can crack the private component of the WEP key in as little as 15 minutes. While there may be proprietary means to address this concern, heretofore no one has developed a method to improve session security in a standards-based wireless environment.

Therefore, what is needed is a WLAN encryption method that is compliant with the 802.11 standard using the WEP algorithm but with improved or enhanced security to minimize the detection of WEP keys during wireless signal exchanges.

### SUMMARY OF THE INVENTION

It is an object of the present invention to provide a WLAN encryption method that is compliant with the 802.11 standard using the WEP algorithm but with improved or enhanced security to minimize the detection of WEP keys during wireless signal exchanges. This and other objects are met by addressing the problem at the access point/client interface. Specifically, the invention involves generating a new encryption key pair (one key for transmission and the other key for reception) periodically. The new key pair is shared between an access point and one or more wireless clients associated with that access point. The period for key changing is selectable dependent upon the signal traffic associated with the network or specific access point and on the capabilities of key discovery crypto analysis attacks.

The present invention is effective in the context of existing standards-based WLANs in that it relies upon the initial security features associated with TLS session initiation and 802.1× user authentication. Those two initial steps provide the means by which the WEP-related exchange keys are securely transferred to wireless end users or clients associated with the network for which authentication has been established. The WEP-formatted keys may be delivered by the network authentication server or, preferably, by the access point with which the wireless client is associated. As indicated, the timing of the changing of the key pair is programmed as a function of the time period or aggregate data traffic associated with then-existing crypto analysis attacks. Further, the key pair is randomly or pseudo-randomly generated.

In brief, the security method of the present invention involves a short set of steps. First, a network session is initiated by a wireless client via an access point. That initialization is secured through the TLS or other suitable protocol. Second, the client is authenticated by the network authentication server using the 802.1× authentication format. Third, the access point creates a pair of keys and marks one as a client receive key and the other as a client transmit key. Fourth, the access point delivers the key pair to a client via 802.1× key list or register. The capacity of the list or register is selectable. The access point may generate individual key pairs for each client with which it is associated. However, for efficiency purposes, each access point may generate a key pair usable by all clients associated with that access point. Fifth, each client receiving a key pair then transmits to the access point using the most recent transmit key. Finally, once the new keys have been transmitted to all associated clients transmits with the latest generated transmit key, the access point switches over to its newly assigned transmit key (the receive key for the client(s)). The process of newly generated key pairs is periodically repeated as designed. Alternatively, the transition to the newly assigned pair may be time-dependent. In that case, a client that fails to switch over to the new key pair would be required to re-authenticate to gain access to the network.

The additional steps of periodic key changing or re-keying and generating the key pair randomly or pseudo-randomly enhances the security of the network once an authenticated session has been established by offsetting the ability to discover such keys by crypto analysis of the encrypted data stream after a relevant volume of data has been exchanged. These and other advantages of the present invention will become more apparent upon review of the following detailed description, the accompanying drawings, and the appended claims.

### BRIEF DESCRIPTION OF THE DRAWINGS

FIG. 1 is a simplified representation of a computer network with wireless communication and including the system of the present invention to enhance signal security in wireless exchanges.

FIG. 2 is a simplified block diagram of the steps associated with signal security in the present invention.

FIG. 3 is a simplified block diagram showing details of the wireless key exchange process of the present invention.

### DETAILED DESCRIPTION OF THE PREFERRED EMBODIMENT OF THE INVENTION

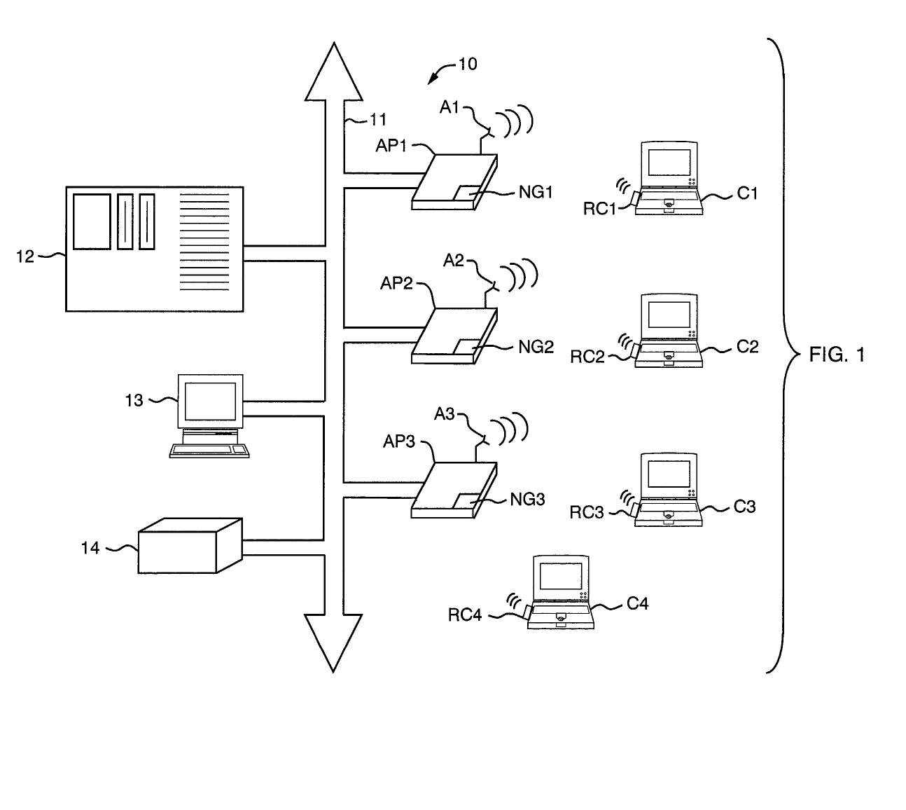

A computer system network 10 shown in FIG. 1 includes wireless communication devices and the means of the present invention to enhance communication security by and among the wireless communication devices. In particular, the network 10 is an Ethernet-type network having a common wired transmission medium 11 connecting together representative components of an authentication server 12, a network management computer 13, an exemplar shared peripheral device 14, and a plurality of access points AP1-AP3. It is to be understood that alternative network types and different numbers and types of components may form the network 10 and that the one depicted is merely for illustration purposes only. Nevertheless, at a minimum, the authentication server 12 is capable of establishing TLS protocol session initiation and 802.lx client authentication including, for example RADIUS identification.

With continuing reference to FIG. 1, the access points AP1-AP3 each includes a random number generator NG1-NG3 and a radio antenna A1-A3. Each of the access points provides the means to enable one or more clients C1-C4 or end users, to communicate wirelessly with the wired authentication server 12 and, theoretically, any other device connected to the network 10. The Roam About R2 TM or the Roam About AP2000™ offered by Enterasys Networks, Inc. of Rochester, N.H., are suitable selections for the access points forming part of the present invention. Each random number generator may be a random or pseudo-random number generator of the type known to those skilled in the art; however, it preferably is designed to avoid repeating sequences and to avoid any known weak keys with respect to the RC4 encryption algorithm. Each of NG1-NG3 is further designed to produce those random numbers as WEP security keys. Electronic signals representing data or other information propagating between the medium 11 and destined for a network client are encrypted by a generated WEP security key to produce encrypted data frames to be transmitted over the wireless medium. One or more frames are thus relayed by the particular access point to one or more clients proximate to the antenna of that particular access point.

Each of the clients C1-C4 includes a network radio card RC1-RC4 having radio reception and transmission means. Enterasys also provides a suitable radio card for that purpose. The radio cards and the access points are configured to communicate via IEEE 802.11 and enable IEEE 802.1× authentication and EAP frame exchange over the network 10. This ensures that two-phase (TLS/802.1×) authentication, using EAP/TLS/802.1×, is followed by key distribution without requiring either a) a static pre-shared WEP key to be used for initial 802.1× authentication, or b) generally allowing a client associated with a particular access point to connect to the network 10 with unencrypted 802.11 data frames. Doing so facilitates both initial authentication and re-authentication as a client roams between access points of the network 10. The exchange of radio waves between a particular client and a particular access point is a function of signal strength. The addition of the random number WEP key generator, and the method herein for changing that key periodically enhances the security of the wireless communication part of the network exchange by changing the encryption of the radioed signals faster than the key can be identified.

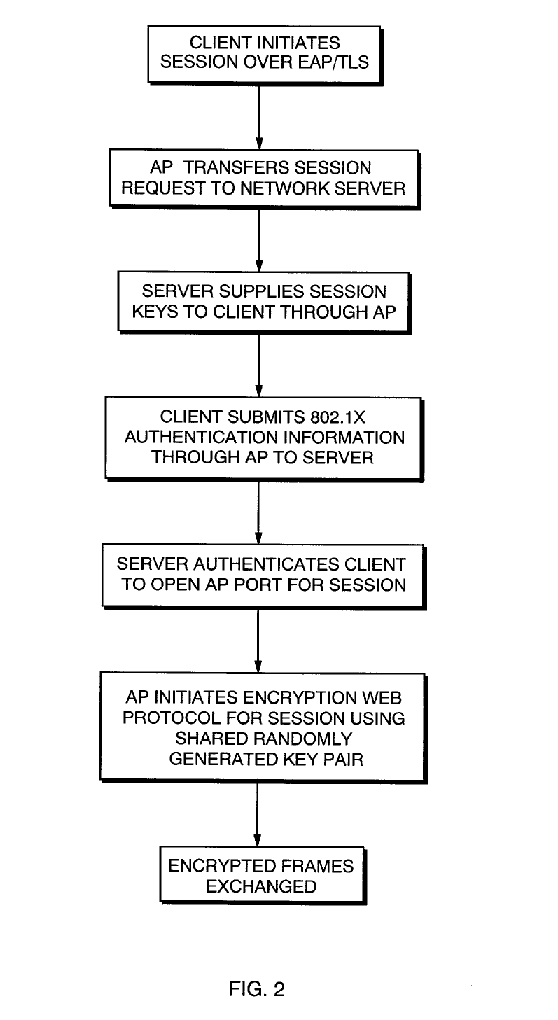

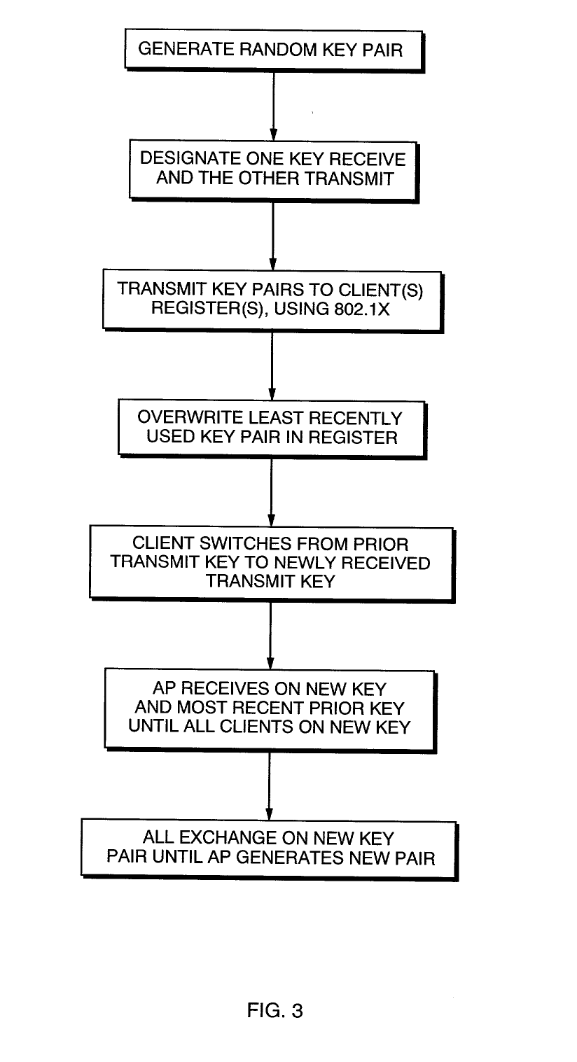

As illustrated in FIG. 2, the security enhancement of the present invention is achieved in the context of existing standards-based security protocols. In particular, any one of clients C1-C4 initiates a network session through the nearest access point under a suitable session initiation process, such as the EAP/TLS/802.1× protocol. The authentication server 12 addresses the initiation request by sending a unique TLS session key to the client through the access point. The client then sends session-encrypted user information to the server 12 for 802.1× authentication. Assuming the authentication occurs, the access point port associated with that client is then unblocked to enable network based signal exchange. Prior to doing so, the relevant access point transmits to the client a pair of WEP-based encryption keys. These keys are pseudo-randomly derived and secured by encryption, using the TLS session keys shared with the client. The authentication server 12 sends these TLS session keys to the access point, as part of the authentication acceptance message. Each key is marked, one as a client receive key and the other as a client transmit key, as represented in FIG. 3. It is to be understood that a plurality of clients associated with a common access point may each receive a unique key pair, or they may all share the same key pair. Assuming shared keys are used, the access point initiates exchanges using the assigned keys.

As illustrated in FIG. 3, the access point and associated client begin network interaction, after authentication, when the access point transmits the randomly generated WEP key pair to the client. The keys are stored in the client register and accessed as a function of whether signal is to be decrypted on reception or encrypted on transmission. In the event a plurality of such key pairs is already registered, the least recently used or oldest pair is overwritten. In a shared key environment, the access point confirms that all connected clients return a message using the most recent client transmit key before beginning to transmit on the most recent client receive key. Alternatively, the access point may use a fixed number of duplicate key messages, i.e., retries, in the absence of positive acknowledgement from the client that the key messages have been received and processed. Once all clients are on the correct WEP key pair, signal exchanges are continued. An important aspect of the present invention is that the key pairs, whether randomly generated or not, are changed over the course of any signal exchange session. As previously noted, current crypto analysis attacks indicate that static keys can be detected. For that reason, the present invention includes the step of exchanging the existing key pair with a newly generated pair; either after a certain number of frames has been processed by the access point, or after a selectable period of time. The number of frames that should be used as a threshold for changing of keys is determined by the algorithms currently in use for crypto analysis based key discovery attacks.

While the present invention has been described with specific reference to a particular embodiment, it is not limited thereto. Instead, it is intended that all modifications and equivalents fall within the scope of the following claims.

What is claimed is:

1. A method for enhancing the security of a wireless local area network including one or more wireless access points associated with one or more clients having a wireless interface card, and a network server, the method comprising the steps of:
a. initiating a network session between one or more of the clients and the network;
b. having the network server authenticate the one or more clients for access to the network via one or more of the access points;
c. generating a pair of encryption keys;
d. transmitting the encryption key pair to the one or more authenticated clients; and
e. periodically replacing the transmitted encryption key pair with a newly generated pair.

2. The method of claim 1 wherein the encryption key pair is randomly generated.

3. The method of claim 1 wherein each access point generates its own encryption key pair.

4. The method of claim 1 wherein each encryption key pair is unique to each client.

5. The method of claim 1 wherein each encryption key pair is shared among all clients associated with a particular access point.

6. The method of claim 1 wherein the encryption key pair is replaced as a function of time.

7. The method of claim 1 wherein the encryption key pair is replaced as a function of frame traffic.

8. The method of claim 1 wherein authentication occurs under IEEE standard 802.1×.

9. The method of claim 1 wherein the Extensible Authentication Protocol is used to authenticate the one or more clients.

10. The method of claim 1 wherein the generated encryption key pair is used for the Wired Equivalent Privacy algorithm.

11. The method of claim 1 wherein a first one of the encryption key pair is designated a receive key and a second one of the encryption key pair is designated a transmit key.
